(19) United States
(12) Patent Application Publication
(10) Pub. No.: US 2010/0085501 A1
(43) Pub. Date: Apr. 8, 2010

(54) HIDDEN LIQUID CRYSTAL DISPLAY DEVICE

(75) Inventor: HUNG-CHANG TSENG, TAIPEI (TW)

Correspondence Address: HUNG-CHANG TSENG;BATON DIGITAL ELECTRONIC TECH. CO., LTD., P.O. BOX 108-00403, TAIPEI, 106, TW

(73) Assignee: BATON DIGITAL ELECTRONIC TECH. CO., LTD., CHUNG-HO CITY (TW)

(21) Appl. No.: 10/711,865

(22) Filed: Oct. 11, 2004

(51) Int. Cl. G02F 1/1333

(52) U.S. Cl. 349/58

(57) ABSTRACT

A hidden LCD device suitable for a vehicle comprises a head rest having a narrow receiving space extending from a side thereof; a gear track is disposed at a lower side of said narrow receiving space of the head rest; a LCD panel is connected to a motor so that the LCD panel can be moved in or out of the narrow receiving space and can be positioned between two head rests so that passengers inside said vehicle can watch entertainment programs displayed on the LCD panel.

### BACKGROUND OF THE INVENTION

1. The Field of the Invention

The present invention relates to a hidden liquid crystal display (LCD) device suitable for a vehicle, and more particularly to a hidden LCD device that can be moved in and out of a narrow receiving space within a seat head rest of a vehicle and one or more passengers can watch entertainment programs displayed on the LCD device. Thus, the need for a LCD device for each passenger can be effectively eliminated.

2. Description of Related Art

Since the invention of cathode ray tube (CRT) display in 1897, CRT display was very popularly applied in television and computer because of the advantages of excellent image resolution and low cost. However, the CRT display has the disadvantages of being bulky, heavy and high radiation; therefore this paved a way to the development of thin film transistor (TFT) LCD, plasma display panel (PDP) and other flat panel display (FPD) displays. Since 90's, the TFT LCD, PDP and other digital products have dominated the display market and been very close to replace the CRT displays. So far, there are about ten different types of display technologies under development besides the CRT display technology, and they would soon be ready for commercialization. According to researchers, the new TFT LCD has great potential and is capable of replacing the CRT display in the near future. Especially after overcoming the technical problems, the TFT LCD is gradually applied in the personal computer replacing the traditional CRT and colored display tube (CDT) display and is becoming the mainstream display.

Besides, the development of PDP has further paved a way to the development of large size display device ever since 1985. During the winter Olympic event in Japan, major Japanese manufacturers presented their latest developed PDP products to the consumers and are fully focussed on manufacturing it.

Display technology is improving rapidly everyday, the field emission display (FED) is being developed similar to TFT LCD, PDP and other high-tech display products to compete with the traditional CRT and CDT.

Because of the advantageous features of finer image resolution, low radiation, non-electromagnetic radiation, small size and low power consumption, the LCD device has gradually become the most popular display device on the market. Most vehicles, for instance, bus, RV and so on, have LCD device installed to bring much more fun for passengers during traveling. However, the LCD device is expensive and increases the risk of vehicle burglary. The expensive LCD device can be easily seen from outside and attract thieves to break in and steal the LCD device and other valuable belongings of the vehicle owner.

Furthermore, the general viewing angle is about 70 degrees and therefore the LCD device has a limitation of the view angle. Thus, a personal LCD device for each passenger inside the car is required. Accordingly, for two persons, at least two LCD devices are required. Therefore, it would be highly desirable if a single LCD device is installed in front of two passengers positioned between them so that both of them could watch the entertainment programs displayed on the LCD device and thereby reduce the number of LCD devices. Thus, the cost can be effectively reduced and this will also substantially reduce the space occupation inside the vehicle.

Furthermore, the strong vibrations during running of the vehicle or in the event of sudden emergency braking of the vehicle, the passengers may be thrown towards front side from their comfortable position and bump against the LCD device. The LCD monitor being fragile can easily get damage from such impact or easily get scratches thereon or even pose a safety hazard to the passengers under such situations. Presently, the LCD device is not being safely stored when not in used, and it is vulnerable to damages or hurt passenger in accidents. For preventing any such damages from occurring either to the LCD monitor or the passengers, some proposed adhering a double sided safety film on the surface of the LCD monitor for protection. However, the double sided film not only renders viewing poor but also needs often replacements, and the glue stain is left behind after removing the double sided film, it is very difficult to be completely removed. Thus, the double-sided film does more damage to the LCD monitor than protect it.

Therefore, to overcome the above defects is an important issue to the manufacturer in the field.

### SUMMARY OF THE INVENTION

Accordingly, in the view of the foregoing, the present inventor makes a detailed study of related art to evaluate and consider, and uses years of accumulated experience in this field, and through several experiments, to create a LCD device suitable for vehicle. The present invention provides an innovated attractive LCD device that can be moved in or out of a seat head rest of a vehicle so that the LCD device can be safely stored within the head rest when not in use or positioned between the seats in front of the passengers so that the passengers can enjoy watching entertainment programs displayed on a single LCD device. Besides, the need of an additional space and attraction for burglary can be eliminated.

According to an aspect of the present invention, the LCD device is installed in a narrow receiving space within the head rest extending from a side thereof. The LCD device can be moved in and out of the narrow receiving space and can be positioned between the two seats in front of the passengers so that the passengers can enjoy watching the entertainment programs displayed on the LCD device. In other words, one or more passengers can enjoy watching a single LCD device and therefore the need for a LCD device for each passenger can be eliminated. Thus, the overall cost can be effectively reduced. After the passenger finishes using the LCD device, the LCD device can be moved back into the narrow receiving space and stored therein to reduce damage to the LCD device or the passengers.

According to another aspect of the present invention, the LCD can be stored within the narrow receiving space within the head rest so that persons other than the owners of the vehicle are unaware of the existence of the LCD device within the vehicle, therefore burglary of the vehicle and monitor can be effectively avoided.

### BRIEF DESCRIPTION OF THE DRAWING

For a more complete understanding of the present invention, reference will now be made to the following detailed description of preferred embodiments taken in conjunction with the following accompanying drawings.

FIG. 1 is an exploded view of a hidden LCD device according to an embodiment of the present invention.

FIG. 2 is an elevational view of a hidden LCD device according to an embodiment of the present invention.

FIG. 3 is a sectional side view showing the hidden LCD device within the head rest of a car seat according to an embodiment of the present invention.

FIG. 4 is a sectional side view showing while using the hidden LCD device according to an embodiment of the present invention.

FIG. 5 is a perspective view showing while using the hidden LCD device according to an embodiment of the present invention.

### DETAILED DESCRIPTION OF PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

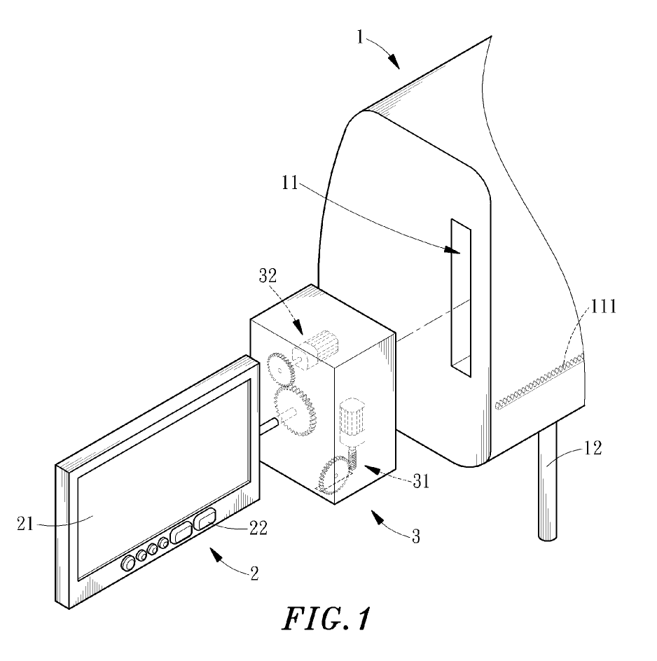

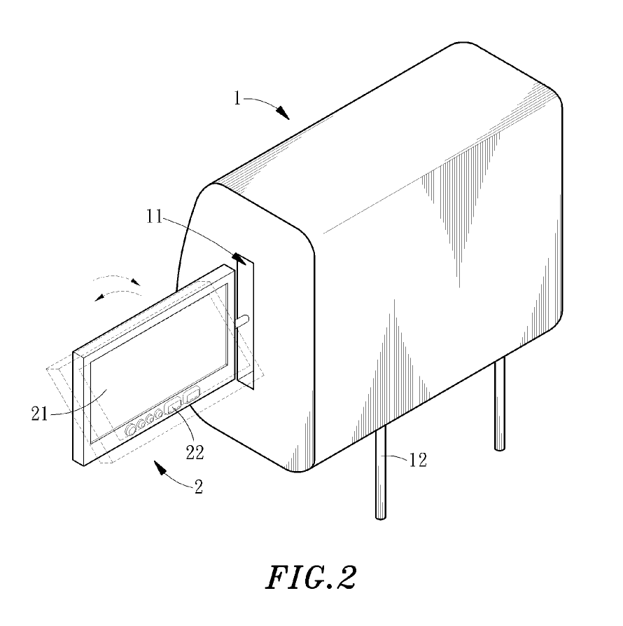

Referring to FIGS. 1 and 2, an exploded view and an elevational view of a hidden LCD device according to an embodiment of the present invention are shown respectively. The hidden liquid crystal display (LCD) device comprises a head rest 1, a LCD panel 2 and a motor 3.

The head rest 1 comprises a narrow receiving space 11 extending from a side thereof, a plurality of supporting elements 12 disposed below the head rest 1 and a gear track 111 disposed at a lower side of the narrow receiving space 11.

The LCD panel 2 comprises a monitor 21 and a plurality of buttons 22 on a surface of the LCD panel 2, wherein the LCD panel 2 can be moved in and out of the narrow receiving space and also can be positioned between the two seats inside the vehicle.

The motor 3 is set above the gear track 111, wherein the motor 3 comprises a motor element 31 connected to the gear track 111 for moving the motor 3 along the gear track 111. The motor device 3 further comprises a rotary element 32 connected to the LCD panel 2 for adjusting the viewing angle.

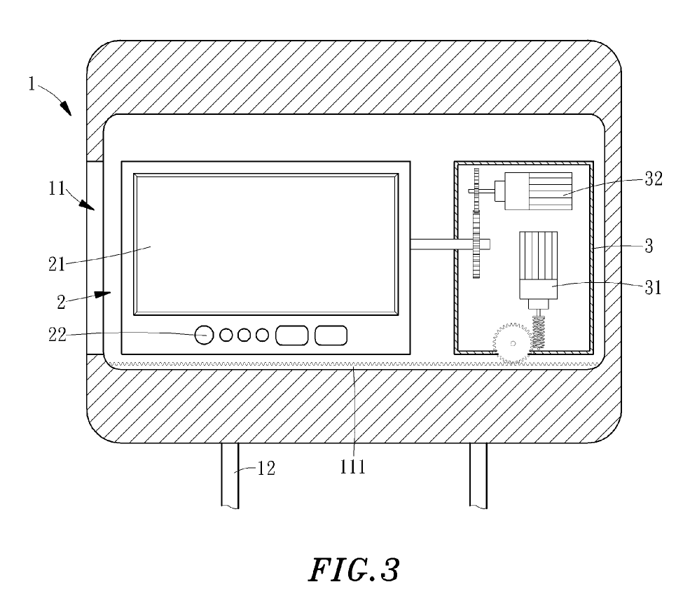

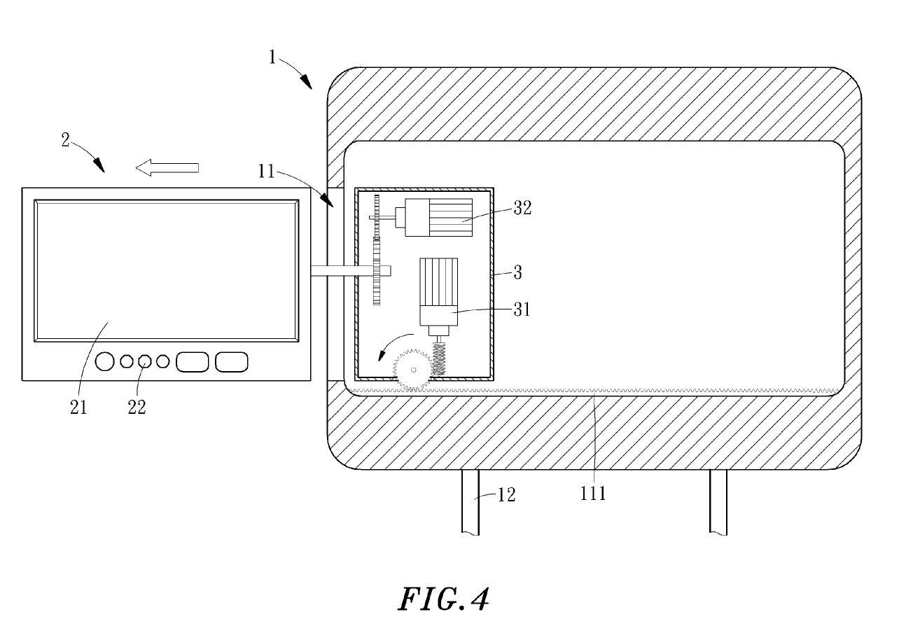

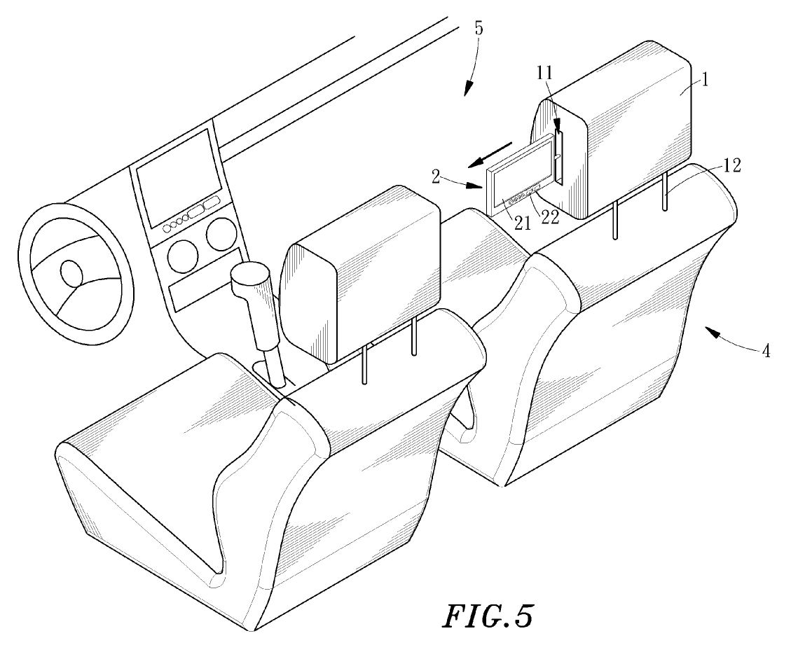

Referring to FIGS. 3, 4 and 5, a sectional side view showing the hidden LCD device positioned within the narrow receiving space, a sectional side view showing while using the hidden LCD device and an elevational view showing while using the hidden LCD device according to an embodiment of the present invention are shown respectively. As shown, the head rest 1 is fixed to the seat 4 by the supporting elements 12, and a passenger can operate the motor element 31 of the motor 3 to drive the motor element 31 along the gear track 111 to move the LCD panel 2 in and out of the narrow receiving space 11 of the head rest 1. The LCD panel 2 is positioned between two seats 4 when the LCD panel is positioned outside the narrow receiving space 11. Thus, the passengers can enjoy viewing the entertainment programs displayed on the LCD panel 2. Accordingly, the need of a LCD device for each passenger can be effectively eliminated. After the passengers finishes viewing the entertainment programs displayed on the LCD panel 2, the passengers can operate the motor 3 to drive the motor element 31 to move the LCD panel 2 back into the narrow receiving space 11 and store it within the head rest 1 to reduce any possible damage to the monitor 21 of the LCD panel 2 or the passengers.

Furthermore, when the hidden LCD device is not in use, the LCD panel 2 can be stored within the narrow receiving space 11, thus the people outside the vehicle 5 would be unaware of the LCD panel 2 within the car 5 and thereby avoid burglary of the vehicle 5 and monitor 21.

Furthermore, the passenger can operate the rotary element 32 to position the LCD panel 2 at a suitable angle for the passengers to enjoy entertainment programs at a better view.

Accordingly, the hidden LCD device of the present invention has at least the following advantages.

1. The hidden LCD device of the present embodiment can be stored within the narrow receiving space within the head rest extending from a side thereof, and the LCD device can be moved in and out of the narrow receiving space and can be positioned between the two seats so that the passengers inside the vehicle can enjoy the entertainment programs displayed on the LCD panel and thus does not require a LCD device for each passenger. Therefore, the cost can be effectively reduced. After the passengers finish using the LCD panel, the LCD panel can be moved back into the narrow receiving space and stored therein to reduce any possible damage to the LCD panel or the passengers.

2. The LCD panel can be stored within the narrow receiving space, thus the people outside the vehicle would be unaware of the LCD panel within the car and thereby avoid burglary of the vehicle and the monitor. Furthermore, the LCD panel does not occupy any space within the car when not in use.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A hidden LCD device, suitable for a vehicle, comprising:
a head rest, comprising a narrow receiving space extending from a side thereof;
a gear track, disposed at a lower side of said narrow receiving space of said head rest; and
a LCD panel, connected to a motor so that said LCD panel can be moved in or out of said narrow receiving space and can be positioned between two head rests so that passengers inside said vehicle can watch entertainment programs displayed on said LCD panel.

2. The hidden LCD device according to claim 1, wherein said LCD panel comprises a monitor and a plurality of buttons on a surface thereof.

3. The hidden LCD device according to claim 1, wherein said motor comprises a motor element moving along said gear track.

4. The hidden LCD device according to claim 1, wherein said motor comprises a rotary element for adjusting a viewing position of said LCD panel.
